(19) United States
(12) Patent Application Publication
(10) Pub. No.: US 2003/0009380 A1
(43) Pub. Date: Jan. 9, 2003

(54) Information display method and apparatus, medium, and program

(75) Inventors: Jun Suzuki, Zama (JP); Toshimitsu Kuroda, Yokohama (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/176,589

(22) Filed: Jun. 24, 2002

(30) Foreign Application Priority Data
Jul. 5, 2001 (JP) 2001-205354

(51) Int. Cl. G06F 17/60; H04M 3/42

(52) U.S. Cl. 705/14; 455/414

(57) ABSTRACT

An information editing apparatus displays, on the street display apparatus, a question in regard to an advertisement and a display identifier corresponding to the question. The viewers who have watched the question originate the display identifiers and answer information pieces for the questions to the information editing apparatus from the mobile terminals. The information editing apparatus collects only the answers of viewers who have the legitimate display identifiers and displays the advertisement based on the collected result on the street display apparatus.

### CROSS REFERENCE TO RELATED APPLICATIONS

This application is related to, and claims the benefit of priority to, Japanese Patent Application No. 2001-205354, filed Jul. 5, 2001 in Japan, the contents of which are incorporated herein by reference.

### BACKGROUND OF THE INVENTION

1. Field of the Invention

The present invention relates to a method of displaying information on a viewer participation type information display apparatus.

2. Description of Related Art

In recent years, sales promotion and advertisement videos have been presented to the public by installing a large outdoor display apparatus that is publicly viewable. However, this display method is identical to the method utilized on an ordinary television display, and various video materials are displayed in a display sequence that is predetermined by the display administrator.

When a street display apparatus of this type has been installed, many people are attracted to the videos displayed on the outdoor display apparatus because the display apparatus is very interesting. However, in the present situation in which even a plurality of outdoor display apparatuses are installed only at one intersection, it is difficult to attract the interest of the general public even by displaying advertisement videos in the one-sided sequence.

Moreover, in the current advertisement business field, an advertiser intensively tends to request the information about the practical cost performance (that is, the value) of the advertisement display. However, in the existing display method, a display administrator cannot present practical information regarding the value to satisfy the advertisers. Therefore, a display administrator has the risk of losing the advertisers and reducing the advertisement income.

For the advertisers, it is a large problem in the current situation, which is flooded with advertisement videos, to consider the attention of the general public with the advertisement of its own company. Since how to attract the advertisement cost is restricted, it is difficult to repeatedly display and broadcast the same advertisement. Accordingly, an advertiser essentially seeks a display method which assures creating a deep impression during each display cycle.

Since the one-sided display method is identical to only television viewing for those viewing the street display apparatus, viewers may not have any particular interest in the displayed videos and therefore may not remember the videos regardless of the kind of video displayed. The public expects that the information in which it is interested be introduced in an information media, regardless of the form of media.

The present invention provides an information display method that solves the problems explained above, enhances the viewers' interest in display information of the street display apparatus, and collects the degrees of interest of the viewers.

### SUMMARY OF THE INVENTION

An information display method of the present invention comprises generating a question about contents and a display identifier corresponding to the question, displaying the question and display identifier on a street display apparatus, receiving an answer information (or answer) to the question from a viewer of the street display apparatus via a mobile terminal carried by the same viewer in combination with the display identifier, collecting the answer information pieces as a group of answers corresponding to the legitimate display identifier among the received group of answers, and displaying desired contents based on the collected group of answers.

Whenever the question is updated, the display identifier is also updated. The display identifier is used to identify to which question the answer of a viewer corresponds, but the goal of the display identifier is to confirm whether a person who has transmitted the answer is a viewer who is actually viewing the display of the street display apparatus. With this confirmation, the street display administrator is now capable of sending a report, including the number of viewers having actually watched the relevant advertisement and the related information thereof, to the advertiser in response to the requirement for a cost performance check of the advertiser. Moreover, when it is designed to send a present to the viewers who have originated the answer, it is possible to select only the viewers who have surely watched the relevant advertisement display as the object persons. In the present invention, the question information (or question) may be displayed only to a web page on the World Wide Web (“www”), to a street display apparatus, or to both.

Moreover, the information display method of the present invention comprises displaying the selection items corresponding to a plurality of contents to the street display apparatuses as the question information, receiving the selection items which viewers desire to watch from viewers as the answer information, and displaying, to the street display apparatus, the contents corresponding to the selection items to which the greatest number of answer information pieces indicate a desire to watch have been returned.

With this information display method of the present invention, viewers have interest in the result of their answers regardless of whether the requested advertisements are displayed, because the possibility for watching the requested advertisements becomes high. Even if an advertisement that is different from the requested one is displayed, the viewers have interest in the advertisements selected by many other viewers. Therefore, the viewers who have originated an answer have interest in the advertisements displayed and keep the contents thereof in their memories for a longer time regardless of the result. In addition, because the contents belonging to the same field are used in the question, it is possible to give to the viewers the impression of not only discrete advertisement but also a plurality of contents of the same field.

Moreover, the information display method of the present invention further comprises collecting answers from viewers by issuing the question to identify what kind of content the displayed information is, displaying the contents of a correct solution based on the result of this collection and displaying also the contents answered as erroneous solution. Since the contents of erroneous answers are also displayed, it is possible to give, to the viewers who have originated an erroneous answer, a chance to memorize the contents of their own answer and a chance to newly recognize the contents of the correct answer. As explained above, the street display administrator can give an intensive impression of the displayed advertisement to the viewers who have watched the same advertisement and is thereby capable of utilizing such higher advertisement display effect for the sales promotion.

Moreover, it is also possible for outdoor display administrator to make the viewers memorize a plurality of contents of the same field, while recognizing the difference between the contents. Since it is a rare case in the advertisement display with the ordinary television broadcast that the advertisements of the same field are continuously displayed, the sequential display method of the advertisements in the same field can provide excellent expectation for advertisement effect, unlike the ordinary television broadcast.

Moreover, the information display method of the present invention is also characterized in that the question is a video captured as a part of the contents. Since only a part of contents is displayed, a degree of entertainment can be enhanced as the quiz and a larger of answers can be collected. In addition, the information display method of the present invention is further comprises receiving user information such as a message from a viewer and favorite images or the like together with the answer from the viewer, and displaying, to the street display apparatus, the collected user information of viewer together with the contents. Thereby, it becomes possible to give to the viewers the expectation that their own message originated the context. Information of images or the like may be displayed on the street display apparatus, and thereby a larger number of answers can be collected.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram showing the conceptual structure of the present invention.

FIG. 2 is a diagram showing a conceptual total process flow of the present invention.

FIG. 3 is a diagram showing a question display image for viewers in the first embodiment of the present invention.

FIG. 4 is a diagram showing an answer accepting web page for viewers in the first embodiment of the present invention.

FIG. 5 is a diagram showing a vote result display image in the first embodiment of the present invention.

FIG. 6 is a diagram showing a contents display image in the first embodiment of the present invention.

FIG. 7 is a diagram showing a contents management table of the present invention.

FIG. 8 is a diagram showing a display identifier table of the present invention.

FIG. 9 is a diagram showing a selection candidate table of the present invention.

FIG. 10 is a diagram showing a viewer management table of the present invention.

FIG. 11 is a diagram showing a background management table of the present invention.

FIG. 12 is a diagram showing a process flow of the content selection display process in the first embodiment of the present invention.

FIG. 13 is a diagram showing a process flow of generation of the captured image in the first embodiment of the present invention.

FIG. 14 is a diagram showing a process flow of the answer information receiving process in the first embodiment of the present invention.

FIG. 15 is a diagram showing a process flow of the collection and content display process in the first embodiment of the present invention.

FIG. 16 is a diagram showing a question display image for viewers in the second embodiment of the present invention.

FIG. 17 is a diagram showing an answer information accepting web page for viewers in the second embodiment of the present invention.

FIG. 18 is a diagram showing a correct answer display image in the second embodiment of the present invention.

FIG. 19 is a diagram showing another selection items display image in the second embodiment of the present invention.

FIG. 20 is a diagram showing a process flow of the content selection display process in the second embodiment of the present invention.

FIG. 21 is a diagram of a process flow of the collection and contents display process in the second embodiment of the present invention.

FIG. 22 is a diagram showing a question display image displayed on the street display apparatus in the third embodiment of the present invention.

FIG. 23 is a diagram showing a question display image on the world wide web (WWW) in the third embodiment of the present invention.

### DESCRIPTION OF THE PREFERRED EMBODIMENTS

The preferred embodiments of the present invention will be explained with reference to the accompanying drawings.

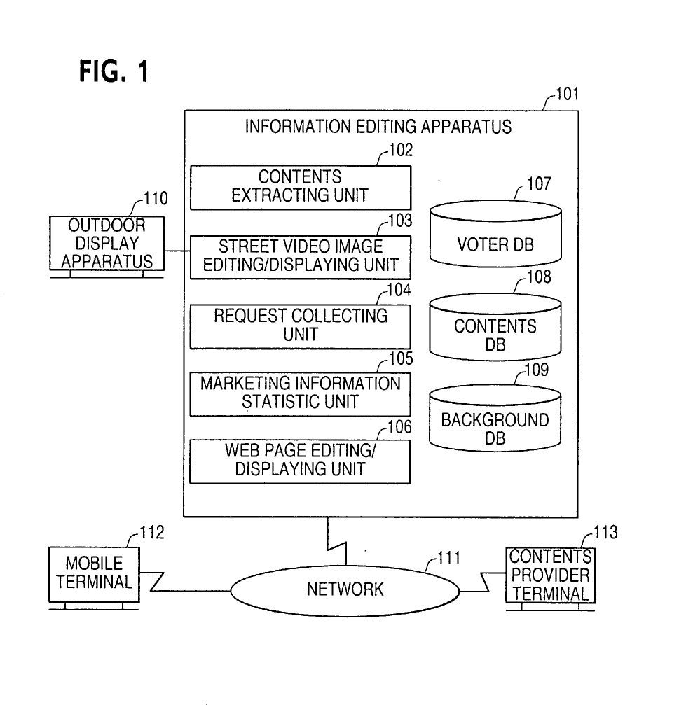

FIG. 1 is a block diagram showing the conceptual structure of the present invention, according to embodiments of the invention. In particular, FIG. 1 illustrates information editing apparatus 101, outdoor display apparatus 110, mobile terminal 112, network 111, and contents provider terminal 113. As shown in FIG. 1, the mobile terminal 112 is coupled to information editing apparatus 101 through network 111.

In the present invention, the information editing apparatus 101 includes a contents database 108 (database hereinafter abbreviated “DB”) accumulating advertisement materials and images obtained by capturing a part of the advertisement materials, a voter DB 107 accumulating answers (or answer information) from viewers, and a background DB 109 accumulating backgrounds as the result of collection of the contents used for questions (or question information) and answers of viewers. The information editing apparatus 101 further includes a contents extracting unit 102 generating and displaying a question image by selecting the contents of the same field from the contents DB 108, capturing partial images of each content, setting the image number of an image sending questions, and sending an instruction to a street video image editing/displaying unit 103 and a web page editing/displaying unit 106 (both of which are included, in the present invention, in information editing apparatus 101). The street video image editing/displaying unit 103 generates and displays the image actually displayed on the street display apparatus based on the question generated with the contents extracting unit 102. The street video image editing/displaying unit 103 also generates and displays a result (or result information) based on the information collected with a request collecting unit 104. The request collecting unit 104 is included in information editing apparatus 101 in an embodiment, and collects the answers from mobile terminals 112 of viewers accepted by the web page editing/displaying unit 106 and accumulates the collection result to the background DB 109 and messages of viewers and images to the voter DB 107.

In the present invention, information editing apparatus 101 further includes a marketing information statistic unit 105, which analyzes various marketing data based on the information accumulated in the background DB 109 and generates the marketing information to be provided to an advertiser. The web page editing/displaying unit 106 generates and displays the image for accepting the answers of a mobile terminal 112 on the web page based on the question information generated with the contents extracting unit 102 and also accepts the answer information inputted from the mobile terminal 112. Moreover, the web page editing/displaying unit 106 monitors the time limit for accepting the answers and displays an answer acceptance end message when the time limit expires. In addition, the web page editing/displaying unit 106 also discriminates the image number inputted from the mobile terminal 112 and accepts only the answers of the legitimate image number.

In the present invention, outdoor display apparatus 110 is coupled to street video image editing/displaying unit 103. In the present invention, mobile terminal 112 and contents provider terminal 113 are coupled to web page editing/displaying unit 106 via network 111.

Although not shown in FIG. 1, the information editing apparatus 101 may additionally include a contents accepting unit providing registration and management of the contents in contents DB 108.

The street display apparatus 110 can be selected from any type of apparatus where the viewers, as an uncertain majority, can watch various display images. For example, street display apparatus 110 may be a large size outdoor display or a large size monitor or television receiver installed within a large building such as an airport, a building, or a department store.

Mobile terminal 112 comprises a mobile terminal device carried by a viewer watching the videos displayed on the street display apparatus, such as outdoor display apparatus 110. In the present invention, mobile terminal 112 may be a mobile telephone, a note-size personal computer, or a personal digital assistant (“PDA”). However, the present invention is not so limited, as any terminal that can be connected to the world wide web (“WWW”) or that can transmit or receive electronic mail may be used as mobile terminal 112.

In an embodiment of the present invention, network 111 comprises the Internet. However, embodiments of the present invention are not so limited as an any type of communication network corresponding to digital data may be used, so long as it assures that the answer and image data or the like from mobile terminal 112 can be transmitted to the information editing apparatus 101, or that the contents provider terminal 113 can transmit the digital contents to the information editing apparatus 101 and read the marketing information generated with the information editing apparatus 101.

In an embodiment of the present invention, contents provider terminal 113 comprises a work station, and various personal computers may be assumed. However, contents provider terminal 113 is not limited thereto, and any terminal can be used so long as it can be connected to the world wide web (WWW) and is capable of transmitting and receiving digital data.

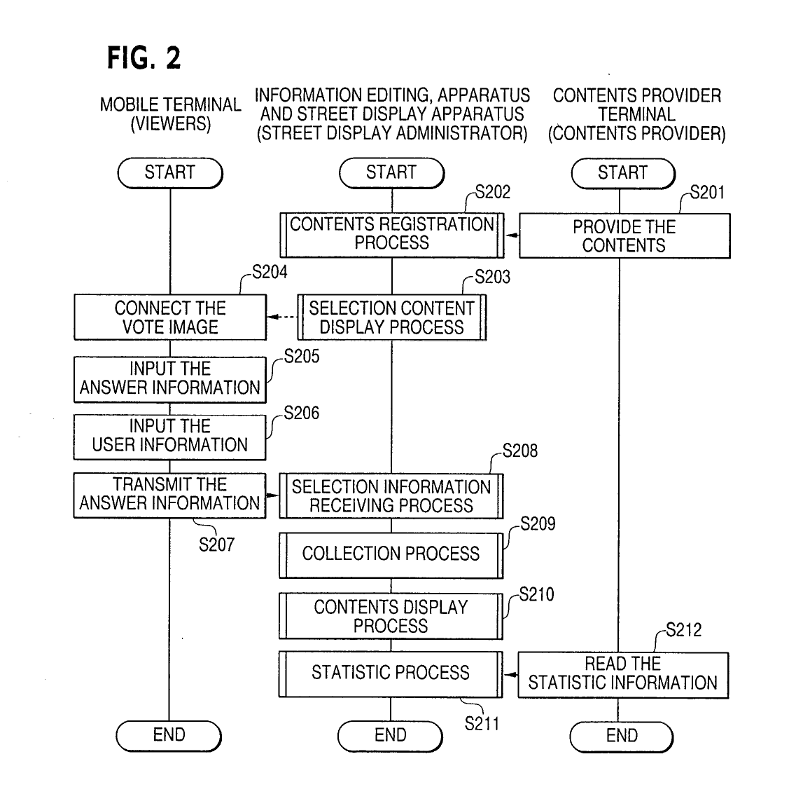

The total process flow of the present invention is shown in FIG. 2. First, a contents provider (advertiser or company entrusted for displaying advertisement from an advertiser) provides contents as the advertisement material to the information editing apparatus 101 (S201). In an embodiment, this providing method can be realized by providing a storage medium or a magnetic tape storing contents to the street display administrator. In another embodiment, it is also possible to provide electronic data of contents online from the contents provider terminal 113 via the network 111.

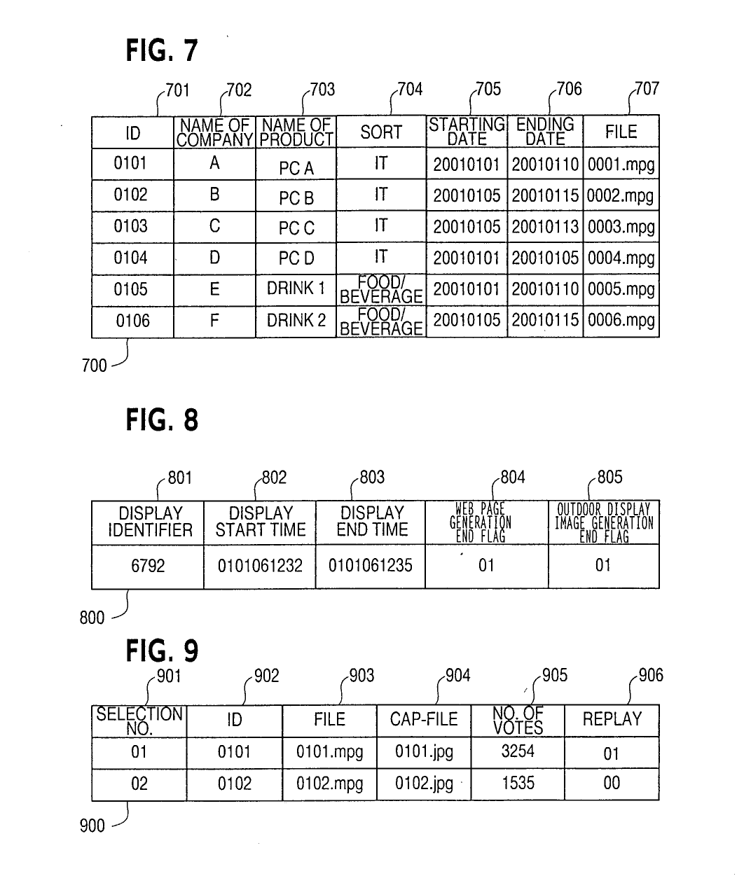

Next, the street display administrator accepts the contents from the contents provider and registers the contents to the contents DB 108 (S202). In this case, the street display administrator inputs a contents management table 700 of FIG. 7 for the management of contents. The contents management table 700 includes at least an identification ID 701 identifying the contents, a name of company as the advertiser of contents or company identification information 702, a name of product 703 to identify the name of contents or an item dealt with the contents, a sort 704 of item dealt with the contents, a starting date 705 for starting the display of advertisement, an ending date 706 for ending the display of advertisement, and a file name 707 of contents material or identification information actually reproducing contents material. All or a part of the management information pieces can be registered online, when the street display administrator prepares for the registered contents on the WWW, with the contents provider using the contents providing terminal 113.

Next, the street display administrator executes the content selection display process (S203) for displaying the question to the street display apparatus 110 or web page using the information editing apparatus 101. This process relates to the contents extracting unit 102, outdoor video image editing/displaying unit 103, and web page editing/displaying unit 106 of FIG. 1. In content selection display process S203, a candidate of advertisement to generate a question is selected depending on the field and validity term of display to generate a capturing image of this candidate and information of candidate advertisement is placed in the management using the selection candidate table 900 as shown in FIG. 9. Moreover, an identifier of display for displaying the question is generated and it is then registered for management in the display identifier table 800 as shown in FIG. 8.

A display identifier is generated for each question and is used to determine whether the answer from viewers is legitimate. Therefore, the information editing apparatus 101 automatically generates the display identifier at random. The display identifier table 800 of FIG. 8 is provided for management of such display identifiers, and includes a display identifier 801, a display start time 802, a display end time 803, a web page generation end flag 804, and an outdoor display image generation end flag 805.

The display start time 802 is the time when display of the question is started in the street display apparatus and the time when display of web page for accepting the answer information from viewers is started. When the street image editing/displaying unit 103 and web page editing/displaying unit 106 have completed the edition of the display image, the time when both are displayed simultaneously is recorded as this display start time 802.

The display end time 803 is the time when display of the question of the street display apparatus 110 and display of the web page for accepting the answer information are closed. Namely, a duration time for displaying a question and an answer accepting page is previously set and when the display starting time 802 is inputted, the time in which the display duration time is added automatically to the display starting time is inputted as the display ending time.

The web page generation end flag 804 updates the flag to “01” indicating generation end from the initial value “00” when the contents extracting unit 102 has received a message notifying that the web page editing/displaying unit 106 has generated a page for accepting the answer of viewers. Moreover, the (street) outdoor display image generation end flag 805 updates the flag to “01”, indicating end of generation, from the initial value “00” when the contents extracting unit 102 has received a message indicating that the street video image editing/displaying unit 103 has generated a question.

FIG. 9 shows a selection candidate table 900. This selection candidate table 900 includes as many rows of data as the number of selection items of question information. In addition, the selection items are also set previously to the predetermined number considering the display area of the street display apparatus 110. However, it is also possible that the street display administrator updates such setting as desired. As the selection number (NO.) 901, a number is set depending on the preset number of the selection items. FIG. 9 illustrates the case where the selection items are set to 2. However, embodiments of the present invention are not so limited, as selection items may be set to a number other than two.

The ID 902 corresponds to and succeeds to the ID 701 of the contents management table 700, while the File 903 corresponds to and succeeds to the file 703, respectively. The Cap-file 904 is a file name of a stationary image corresponding to that for which the contents extracting unit 102 regenerates a contents material corresponding to the File 903 and then stores a part of such image to the contents DB 108 through the capturing and the stationary image corresponding to the Cap-file 904 is displayed as the question. This captured image may be generated as required in the side of an outdoor display administrator or may be registered by the contents provider on the online basis to the information editing apparatus 101 from the content provider terminal 113 or may be attained by capturing the particular image through instruction to the street display administrator. As the number of votes 905, the number of answer information pieces of viewers obtained with the request collecting unit 104 is recorded and the initial value “00” is set in this step. Replay 906 is the identifying information indicating whether each content of the selection number 901 is replayed on the street display apparatus 110. The initial value of replay 906 is set to “00” in this step and this value is updated to “01” by the street video image editing/display unit 103 when the contents material corresponding to the file 903 is replayed on the street display apparatus 110 based on the collection result of the request collecting unit 104.

Referring again to FIG. 2, when the information editing apparatus 101 completes the content selection display process S203 and the question information is displayed on the street display apparatus 110, a viewer extends, upon watching the question information, the connection with a mobile terminal 112 to the Web page instructed on the image of the street display apparatus 110 in order to originate the viewer's own answer information to the street display administrator (S204). Thereafter, a viewer selects, upon input of the display identifier and the viewer's own nickname or the like, the intended contents selection item (S205). Next, the viewer inputs or selects a message or an image to be originated (S206) and then transmits this data to the information editing apparatus 101 via the network 111 (S207). Any type of transmission method, may be used. For example, origination of an electronic mail based on the JAVASCRIPT process included in a web page or information data inputted to the answer information accepting page 400 with the CGI process to the WWW server of the information editing apparatus 101 may be directly accepted.

The information editing apparatus 101 executes the process for receiving the answer information from the mobile terminal 112 of a viewer (S208). In otherwords, a program is generated to determine whether a viewer has instructed the transmission of an answer within the answer accepting time when the web page editing/displaying unit 106 has generated the web page to accept the answer or whether the display identifier corresponds to the answer that is currently accepted. This program is generated, for example, as JAVASCRIPT process of HTML or CGI process between the client terminal and the server. Therefore, the setting is made so that the answer is not transmitted when the transmission instruction accepted does not correspond to any condition explained above. The answer which is generated within the answer accepting time and includes the legitimate display identifier is transmitted to the information editing apparatus 101 via the network 111, for example, the Internet.

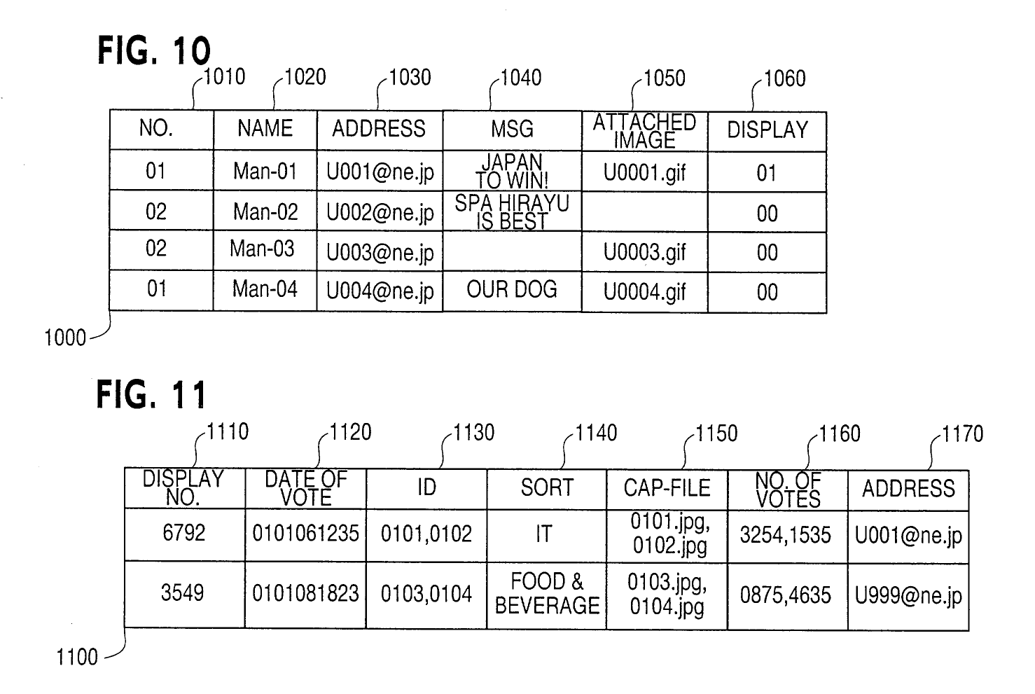

Referring again to FIG. 2, the answer of a viewer received by the information editing apparatus 101 is then collected with the request collecting unit 104 (S209). The request collecting unit 104 registers each answer information to the voter DB 107. The voter DB 107 executes management of answer information and also stores the image data originated from a viewer using a viewer management table 1000 as shown in FIG. 10.

The viewer management table 1000 shown in FIG. 10 is now explained. In FIG. 10, the selection number (NO.) 1010 is a selection number chosen by each viewer. The selection number 1010 becomes a certain selection number 901 in the selection candidate table 900. The Name 1020 is a nickname inputted with a viewer for identifying the viewer. The address 1030 is an e-mail address from which an answer originated. The MSG 1040 is a message inputted from a viewer. The attached image 1050 is a file name or identification information corresponding to the image which has been transmitted from a viewer. In some cases, the MSG 1040 and attached image 1050 are not inputted. In such an instance, those fields remain blank. The display 1060 is a display flag indicating whether a display is made on the street display apparatus. The display flag of the relevant part is initially set to the initial value “00” and is then set to “01” when the viewer data is displayed.

Moreover, during the collection process S209, the request collecting unit 104 records the answer to the viewer management table 1000 and simultaneously counts up the number of votes 905 of the relevant record in the selection candidate table 900 corresponding to the selection number 1010 in the viewer management table 1000.

When the answer accepting time is matured, the request collecting unit 104 selects the contents to be displayed for replay on the street display apparatus based on the number of votes 905 and issues an instruction to the street video image editing/displaying unit 103 to display the relevant contents on the street display apparatus 110 (S210). Moreover, while the contents are displayed for replay, a message 1040 of the viewer who has selected contents displayed for replay the video image corresponding to the attached image 1050 are sequentially displayed based on the viewer management table 1000. In one embodiment, as the viewer data is displayed, the display flag 1060 of the viewer management table 1000 is updated to indicating that the data is already displayed. However, embodiments of the present invention are not so limited, as another value may be used to indicate that data is displayed.

When the contents display process S210 is completed, the marketing information statistic unit 105 accumulates the records of question information and answer information into the background DB 109 (S211). FIG. 11 shows a background management table 1100. The display number 1110 succeeds to the information of display number 801 of the display identifier table 800. The date and time of vote 1120 also succeeds to the display end time 803. The ID 1130 succeeds to the ID 902 of all records of the selection candidate table 900 (for example, 0101 and 0102 in FIG. 9) in the sequence of the selection number 901. The sort 1140 finds the relevant ID 701 from the contents management table 700 using the leading identifier of ID 1130 as a key and succeeds to the sort 704 of such contents data. The Cap-file 1150 succeeds to the all information pieces of Cap-file 904 of the selection candidate table 900 in the sequence of the selection number 901. The number of votes obtained 1160 succeeds to the number of votes obtained 905 of all records of the selection candidate table 900 in the sequence of the selection number 901. In an embodiment, the address 1170 succeeds to the address 1030 of a viewer of which display flag is “01” (displayed) in the display 1060 of the viewer management table 1000. However, embodiments of the present invention are not so limited, as another value may be used in displaying flag 1060 to trigger address 1170.

When the marketing information statistic unit 105 completes data accumulation of this time to the background DB 109, all data in the display identifier table 800 and selection candidate table 900 as well as all image files originated from the viewers of the voter DB 107 are deleted as the reparation for the content selection display process S203 for displaying the next question information. Moreover, the marketing information statistic unit 105 generates various statistic information pieces for each contents provider based on the information of the background DB 109 as the preparation for exclusive Web page for each contents provider with the web page editing/displaying unit 106. When required, each contents provider can read various statistic information pieces in its own exclusive web page (S212).

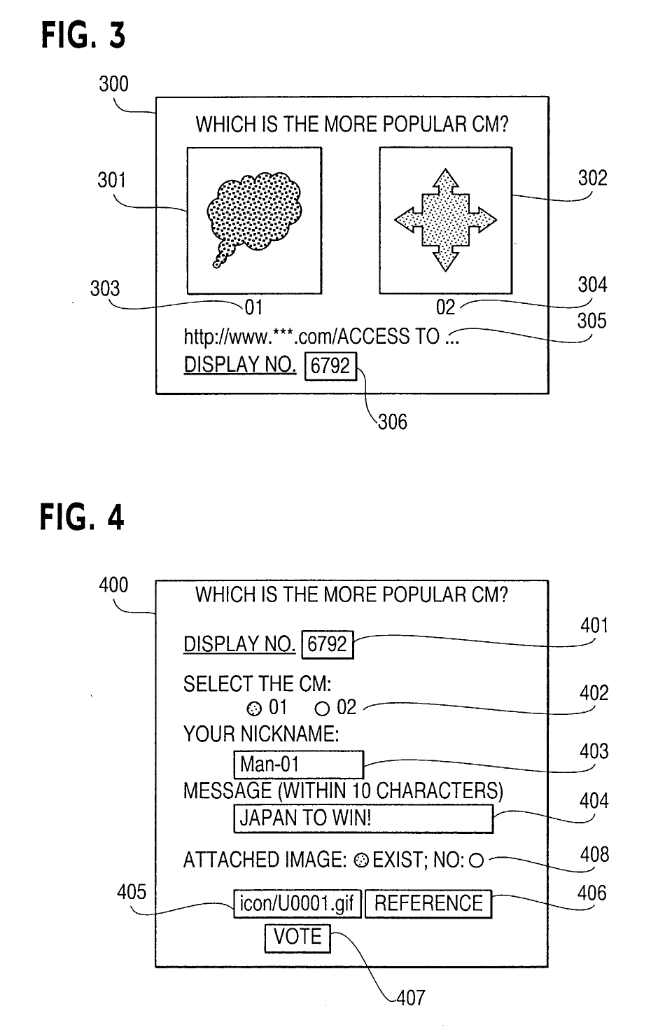

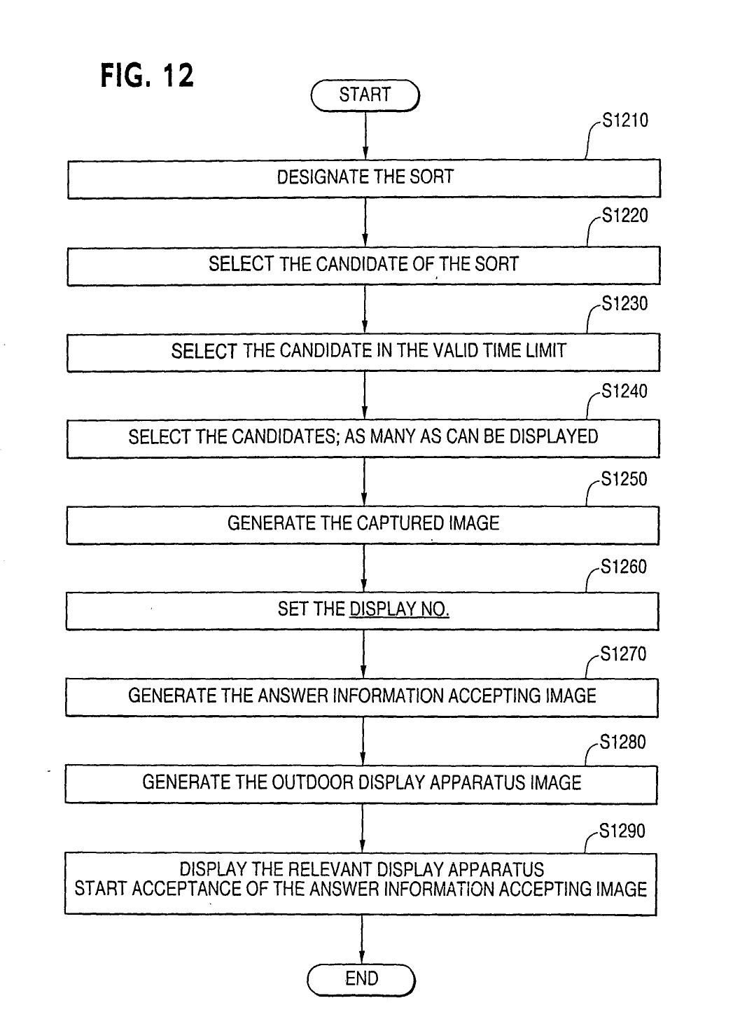

Next, the first embodiment of the present invention will be explained with reference to the display examples of FIG. 3 to FIG. 6 and the process flows of FIG. 12 to FIG. 15. In the first embodiment, the captured image, from which a part of each content has been removed, is presented to viewers with questions for a plurality of contents of the same field. The viewers are then urged to vote the desired contents. The contents having obtained the maximum number of votes are replayed together with the user information of viewers who have voted.

First, the part corresponding to the content selection display process S203 of FIG. 2 will be explained with reference to the flow diagram of content selection display process of FIG. 12.

First, the field of contents is designated (S1210). In this case, the street display administrator can input this field designation to the contents extracting unit 102 whenever the question is generated, but it is also possible for the contents extracting unit 102 to automatically designate the field on the registration date depending on the previously generated field designation schedule or to automatically designate the field at random.

In the following stages of the process, an example will be explained in which the “IT” indicating the information apparatus•home information appliance•electronic goods is designated and the question information pieces are displayed on the street display apparatus from 12:32, Jan. 6, 2001.

In the following example, 2 contents for display are selected from among 6 contents. That is, the number of contents for display is selectively reduced (or squeezed) from 6 to 2 in the following example, by selecting the contents based upon the SORT 704 field and the ENDING DATE 706 field shown in FIG. 7.

Next, the contents are selected first based on the designated field using sort 704 of the contents management table 700 as the key (S1220). Since the “IT” field is designated (currently, for example) for the four records in 0101 through 0104 of ID 701, the four records having “IT” in the SORT field 704 are selected from the six entries in the contents management table 700. The two remaining entries not having “IT” in the SORT field 704 are not selected.

When the relevant field is selected, candidates having a valid display period are selected with reference to the starting date 705 and ending date 706 (S1230). In an embodiment, although not shown, the current date data of Jan. 6, 2001 is obtained from a time management program in conjunction with the information editing apparatus 101. However, embodiments of the present invention are not so limited, as other dates may be used.

Since the record having ID 701 of 0104, among the four records selected based upon the above-mentioned field designation, has an ending date 705 (Jan. 5, 2001) which predates the current date (Jan. 6, 2001), this record is deleted from the pool of selected candidates and the three records designated 0101 to 0103 in ID 701 are selected as the selection candidates.

Moreover, the contents extracting unit 102 selects the selection candidates up to the number of records corresponding to the display time (S1240). In the example of question display image of the street display apparatus 110 of FIG. 3, two display contents frames 301 and 302 are provided to display the question information pieces of two contents with two images. In an embodiment, although not shown, “2” is set to the selected candidate number table of the contents extracting unit 102. Alternatively, at S1240, the street display administrator may input each selected candidate number whenever required from the input interface.

In this example, three contents are selected as the candidates and therefore further selection is necessary. For selection purposes, the contents extracting unit 102 selects at random one of the selected candidates. Alternatively, although not shown, a record may be selected depending on the candidate selection program conforming to a predetermined rule. An example of a predetermined rule would be a table recording the number of times of display for replaying of each content is stored in the background DB 109, and thus the contents having the least number of times of display for replay among the remaining selected candidates are sequentially selected.

In the above-mentioned example, it is assumed that the records having the identifiers 1010 and 0102 in ID 701 are selected through random selection.

When the contents are selected up to the value as many as the display time, the contents extracting unit 102 sequentially writes, for the selected two records, the ID 902 and file 903 of the selection candidate table 900 with reference to the contents management table 700. Moreover, as the number of votes obtained 905 and the replay flag 906, the initial value “00” is set respectively.

Next, the contents extracting unit 102 generates a capturing video image file of the relevant contents in the contents DB 108 with reference to the file 903 of the selection candidate table 900 and writes the file name of such capturing video image into the Cap-file 904 (S1250).

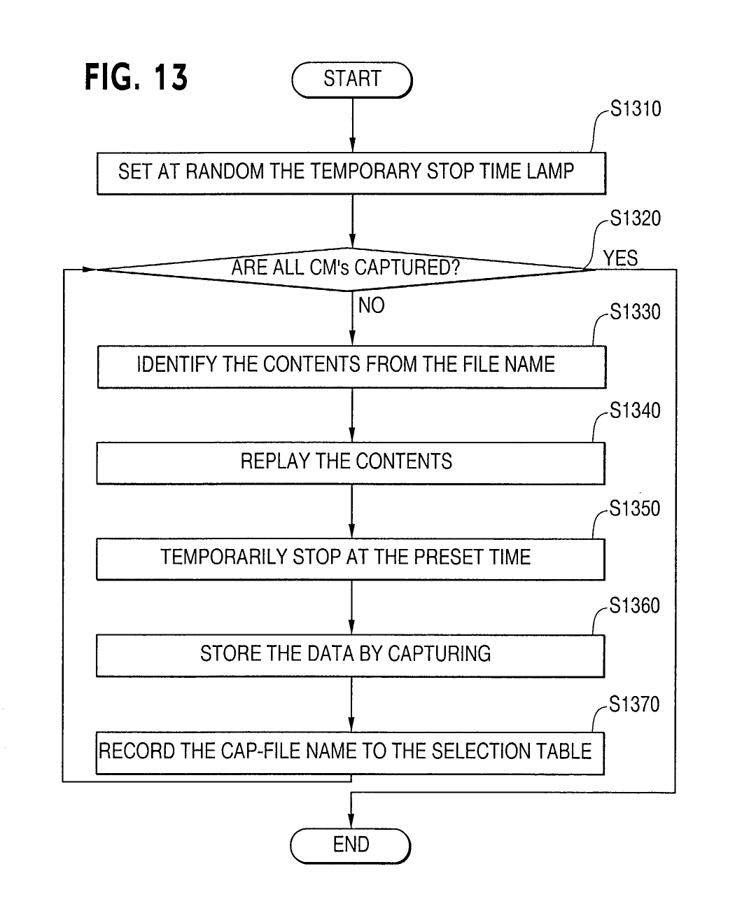

Generation of the capturing video image is based on the process flow of FIG. 13. First, the time for temporarily stopping the replay of all contents of the selection candidate is set at random (S1310). It is then determined whether all contents are captured depending on existence of file name in the Cap-file 904 (S1320). If capturing of all contents is not yet completed, the contents corresponding to the file name of the contents file 903 where the Cap-file 904 is blanked are identified from the contents DB 108 (S1330). Such contents are then replayed (S1340). Thereafter, the replay is temporarily stopped (S1350) according to the temporary stop time set at S1310 the video image in the temporary stop condition is stored as a file in the contents DB 108 by capturing (S1360). This file name is then written into the Cap-file 904 of the relevant contents (S1370) and the process returns again to S1320. Thereby, when the file name is entered to all Cap-file 904 at S1320, the process flow for the capturing video image generation is completed and the process goes to S1260 of FIG. 12.

In this embodiment, it is assumed that display time of all contents is set at 15 seconds or 30 seconds to account for the characteristics of a video commercial. Therefore, if the required replay time is different in the contents, the management of the required replay times of contents is executed using the contents management table 700 and when each content is to be captured, reference is made to the required replay time of each content and the timing for temporary stop must be set within this replay time.

In this embodiment, it is assumed that the image as a whole in the timing that the constant time has passed is captured, but it is also possible that a part of the image (for example, right half of the total image) in the desired replay timing of contents is extracted as the capturing image.

Returning to FIG. 12, when the capturing video image generation at S1250, as explained above, is completed, the contents extracting unit 102 sets the display number to identify the current question and writes it into the display identifier table 800 (S1260). A unique display number is set at random automatically.

Next, the contents extracting unit 102 instructs the web page editing/displaying unit 106 to generate the web page to accept the answer information of viewers based on the selection candidate table 900 and display identifier table 800 (S1270).

An example of answer accepting page is shown in FIG. 4. On the accepting page, a viewer is requested to input a display number in input area 401, and is requested to: select a selection item 402 for desired watching, and input a viewer's nickname in input area 403, a message in input area 404, and a designation of an attached image in input area 405 of attached image. The selection item 402 corresponds to the selection number 901 of the candidate selection table 900. In FIG. 4, only the selection number is displayed, but the related information such as the corresponding name of company and contents may be displayed from the contents management table 700 by referring to the ID 902 of the candidate selection table 900. For the designation 405 of the image to be attached, a viewer selects the directory of files which the viewer wants to display on the street display apparatus from their own mobile terminal, network or the other accessible information apparatus connected to the network. A viewer is allowed to directly input the directory of the image file to the designated input area 405 or browse the directory of the file displayed with the reference button 406. In an embodiment, upon inputting all pieces of information pieces, a viewer depresses a vote button 407 to transmit the answer information to the information editing apparatus 101. However, embodiments of the present invention are not so limited, as other methods of “voting” may be used. For example, a touch screen requiring physical contact with the screen as opposed to a button being depressed, could be used. When the accepted page 400 is generated in the web page editing/displaying unit 106, end of generation is signaled to the contents extracting unit 102. Here, the contents extracting unit 102 updates the web page generation end flag 804 of the display identifier table 800 to “01” from “00”.

Returning to FIG. 12, when the Web page generation end flag 804 is changed to “01”, the contents extracting unit 102 instructs the street video image editing/displaying unit 103 to generate a question to be displayed on the street display apparatus 110 on the basis of the selection candidate table 900 and the display identifier table 800 (S1280).

FIG. 3 shows an example of the question. A question display 300 is composed of capture image frames 301 and 302, selection numbers 303 and 304, URL 1305 of an answer accepting web page and a display number 306. The selection numbers 303 and 304 are indicated with the fixed display and correspond to the selection number 901 of the selection candidate table 900. In an embodiment, in the capture image frame 301, a video image corresponding to “0101.jpg”, in the Cap-file 904 of the record in which the selection number 901 of the selection candidate table 900 is “01”, is selected from the contents DB 108 and is then displayed. In the same manner, a video image of which Cap-file 904 is “0102.jpg” is displayed in the capture image frame 302. Moreover, as the display number 306, “6792” which is recorded in the column of the display number 801 of the display identifier table 800 is displayed. The URL 305 of the answer information accepting page may be fixed without relation to questions or may be designated differently depending on questions. However, embodiments of the present invention are not so limited as other image file names and field contents may be used.

The street video image editing/displaying unit 103 signals, upon completion of generation of the question display 300, the completion message to the contents extracting unit 102. When it receives this message the contents extracting unit 102 changes the street display image generation end flag 805 of the display identifier table 800 to “01.”

The contents extracting unit 102 displays, through the process flow explained above, the question display 300 to the street display apparatus 110, and simultaneously displays the answer information accepting web page 400 to the URL 305 of the answer information accepting web page (S1290). When the web page generation end flag 804 and the street display image generation end flag 805 of the display identifier table 800 becomes “01”, the contents extracting unit 102 writes the time and date of this timing into the display starting time 802 to start the display of the question display 300 and answer accepting page 400.

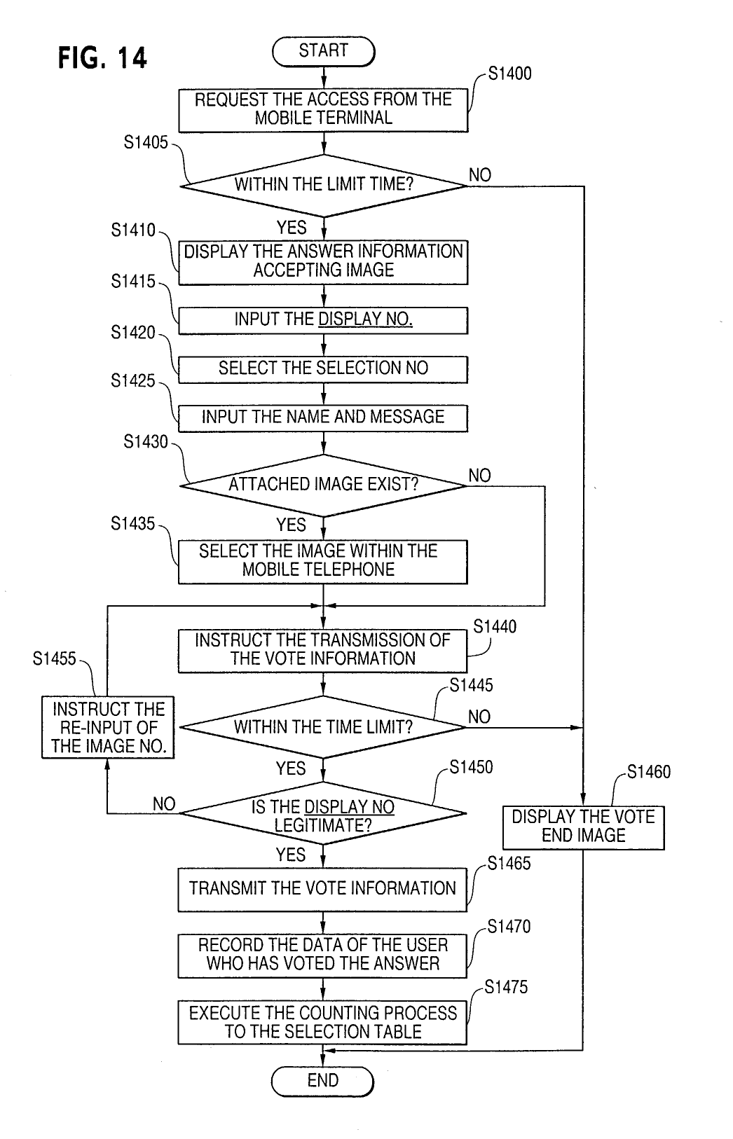

FIG. 14 shows a process flow for accepting the answer from viewers. First, when the web page image editing/displaying unit 106 receives an access request to the answer accepting page 400 from a mobile terminal 112 (S1400), the Javascript program installed in the answer information accepting page 400 determines whether the access time is in the range between the display starting time 802 and the display ending time 803 of the display identifier table 800 (S1405). If the access time is within the range, the process goes to S1410. Moreover, when the access time is determined to be out of the range, a web page indicating that the acceptance of this time is ended is displayed with the Javascript processing program. Simultaneously, the request collecting unit 104 instructs the street video image editing/displaying unit 103 to close the question display 300 and then displays in turn a page indicating that the acceptance of this time is ended (S1460).

When the access time is within the limited time at S1405, the information of the answer information accepting web page 400 is transmitted to the mobile terminal 112 which is accessed with the web page image editing/displaying unit 106 to display this page on the mobile terminal 112 (S1410).

The display number 401 displayed in the question display 300 is inputted in the mobile terminal 112 (S1415) to select the desired selection item 402 to be watched (S1420). In the example of FIG. 4, the selection item 402 is provided as a radio button and a viewer is selecting “01”. However, any other selection method may be used in a different embodiment. Next, the viewer's nickname 403 and a message 404 are inputted to the accepting page 400 (S1425). Thereafter, the viewer determines whether the image should be transmitted with a radio button 408, indicating existence of image attached (S1430). If the image attached (EXIST) is selected, the image file directory is inputted directly to the input area 405 or the reference button 406 is depressed to designate the attached image from the reference file directory (S1435). When the vote button 407 is depressed, it is instructed to transmit the above answer information to the information editing apparatus 101 (S1440).

When the vote button 407 is depressed, the Javascript program installed in the web page determines whether the time when the vote button 407 is depressed is within the range between the display start time 802 and display end time 803 or not under the management of the display identifier table 800 (S1445). If this time is not in the range of the limited time, the answer information is no longer transmitted to the information editing apparatus 101 and the Javascript program displays a notifying message indicating that the vote is no longer accepted (S1460). When the determination result is within the range of limited time, the Javascript program determines whether the input display number 401 is matched with the display number 801 of the display identifier table 800 (S1450). If the display number is not matched, a web page instructing a viewer to input again the legitimate display number 401 is displayed (S1455). When the display number is matched at S1450, the input answer and user information are transmitted to the information editing apparatus 101 (S1465). As the transmitting method, any type method can be selected, for example, from origination of electronic mail based on the Javascript process or direct transmission of the information data inputted to the answer accepting page 400 with the CGI process to the WWW server of the information editing apparatus 101 or the like.

Upon reception of the answer, the request collecting unit 104 accumulates the answer into the voter DB 107 for all viewers (S1470). Namely, the request collecting unit 104 records the answer from a viewer in the viewer management table 1000 of the voter DB 107 and also stores the attached image data in the voter DB 107. Next, the request collecting unit 104 refers to the selection number 1010 of the viewer management table 1000 and adds 1 to the number of votes 905 obtained of the relevant record in the selection candidate table 900 (S1475).

The watching requests of viewers are accepted by repeating the process of receiving the selected information at S208 for each access of the mobile terminal 112 of viewer within the limited time. When the display end time 803 of the display identifier table 800 is matured, the request collecting unit 104 executes the final collecting process S209 and the contents display process S210 to display for replay of the advertisement contents on the street display apparatus 110 based on the collection result. However, since the recording of answer information of viewer S1470 and the count process S1475 to the selection candidate table 900 are being executed in some cases at the display end time 803, it is allowed to set the start time of the collecting process S209 with a constant time delay from the display end time 803.

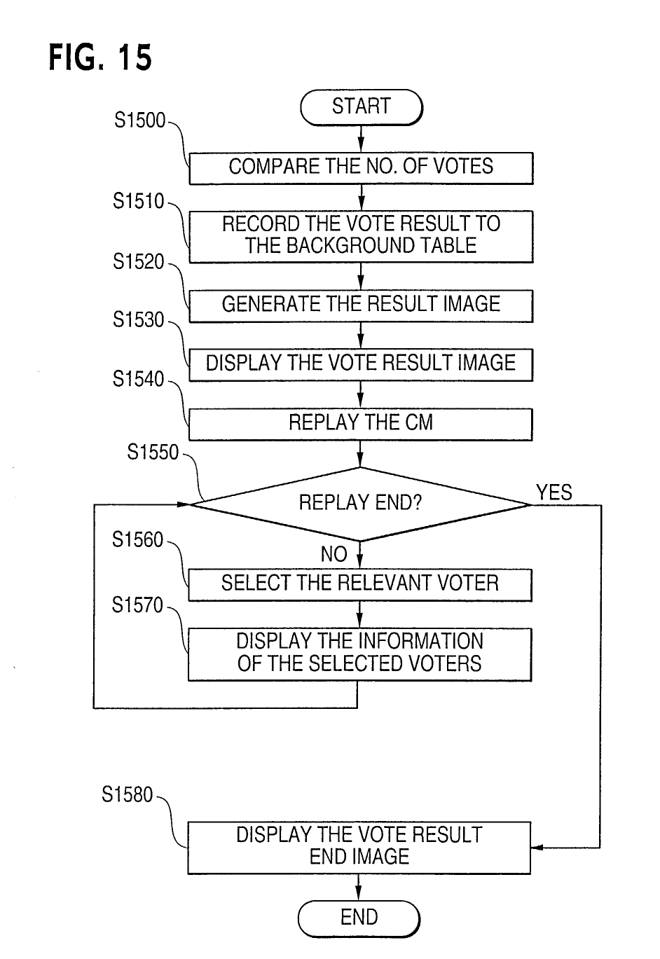

FIG. 15 shows a process flow of the collecting process S209 and contents display process S210 to be executed with the request collecting unit 104.

First, the request collecting unit 104 compares the number of votes obtained 905 among the records recorded to the selection candidate table 900 and updates the replay flag 906 of the record having obtained the maximum number of votes (S1500). In the example of FIG. 9, since the number of votes for content of the selection number “1” is larger than the number of votes for content of a different selection number, the replay flag 906 of this content is changed to “01” from “00”. The replay flag 906 may be given the information which suggests the sequence of the number of votes obtained of each record.

Next, the request collecting unit 104 records the information of the selection candidate table 900 to the background DB 109 (S1510). That is, the request collecting unit 104 writes, from the display identifier table 800, the display number 801 and display end time 802 to the display number 1110 and date and time of vote 1120 of the background management table 1100 and moreover writes the ID 902, Cap-file 904 and number of votes 905 of the selection candidate table 900 and the sort 1140 with reference to the contents management table 700 based on the ID 902. In the example of FIG. 11, a plurality of data is stored in the sequence of the selection number 901 of the selection candidate table 900 to the ID 1130, Cap-file 1150, and number of votes 1160.

Next, the request collecting unit instructs the street video image editing/displaying unit 103 to generate the vote result display 500 and contents play display 600 to be displayed on the street display apparatus 110 (S1520).

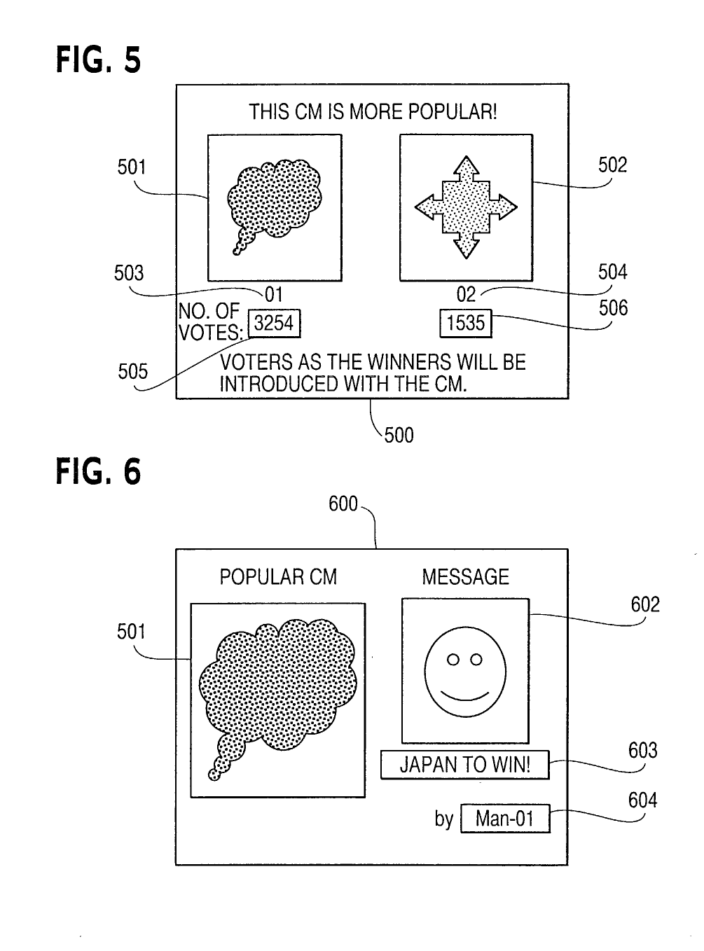

FIG. 5 and FIG. 6 show an example of the vote result display image. FIG. 5 shows a vote result display image 500. The vote result display 500 is formed at least of captured images 501 and 502 of selection candidate, selection numbers 503 and 504, and number of votes 505 and 506 of each candidate. The captured images 501 and 502 and the number of votes 505 and 506 correspond to the selection numbers 503 and 504 and are determined by referring to the Cap-file 904 and number of votes 905 stored in the record of the selection number 901 of the selection candidate table 900. Otherwise, the captured images 501 and 502 and the number of votes 505 and 506 may be determined by referring to the background management table 1100. Moreover, it is also enough when the viewers only know from the vote result display image 500 which image has obtained the larger number of votes, in place of displaying the number of votes 505 and 506 in the display image 500.

FIG. 6 shows the contents play display image 600 displayed after the vote result display image 500 is displayed for a constant period on the street display apparatus 110. The contents play display image 600 is formed at least of a content played 601 having obtained the maximum number of votes, an attached image 602 of a viewer further extracted from the viewers having selected the contents of the maximum number of votes, a message 603, and a nickname 604. The replay content 601 is set to replay the contents data stored in the contents DB 108 corresponding to the file 903 when the contents display image 600 is displayed by referring, with the request collecting unit 104, to the file 903 of the record in which the replay flag 906 of the selection candidate table 900 is set to “01”. A method of determining the data in relation to the user information of the other viewers will be explained later.

Returning to FIG. 15, when the information suggesting that generation of the vote result display image 500 and contents display image 600 is completed is received from the street video image editing/displaying unit 103, the request collecting unit 104 instructs the street video image editing/displaying unit 103 to display the vote result display image 500 for the constant time (S1530) and thereafter start the play of the contents of the maximum number of votes by switching the image to the contents display image 600 (S1540).

When the content is replayed, the request collecting unit 104 discriminates the end of replay of the content (S1550). If the replay is being continued, the request collecting unit 104 extracts the user information of a viewer displayed on the contents display image 600 (S1560) and instructs the street video image editing/displaying unit 103 to display the extracted user information of a viewer on the street display apparatus 110. Here, the process returns to the step S1560 to determine whether the content is still being replayed or not. Here, a viewer is extracted at random from the record matched with the selection number 901 where the replay flag of the selection candidate table 900 is “01” with the request collecting unit 104 by referring to the selection number (NO.) 1010 of the viewer management table 1000. Here, the request collecting unit 104 updates the display flag 1060 of the extracted record to “01” from “00”, writes the extracted viewer address 1030 to the address 1170 of the background management table 1100, and outputs, respectively the Name 1020 of the viewer record in which the display flag is “01” to the nickname 604, MSG 1040 to the message 603, and the video image data corresponding to the attached image 1050 to the attached image 602. In FIG. 10, a viewer with the name “Man-01” in NAME 1020 is extracted from the viewers who have selected the selection number 1010 of “01” of the maximum number of votes and thereby the user information of the viewer “Man-01” is displayed in FIG. 6. Moreover, the first record of FIG. 11 (the display number 1110 is “6792”) indicates the background information of the vote result. Extraction of the viewer may also be conducted at S1510.

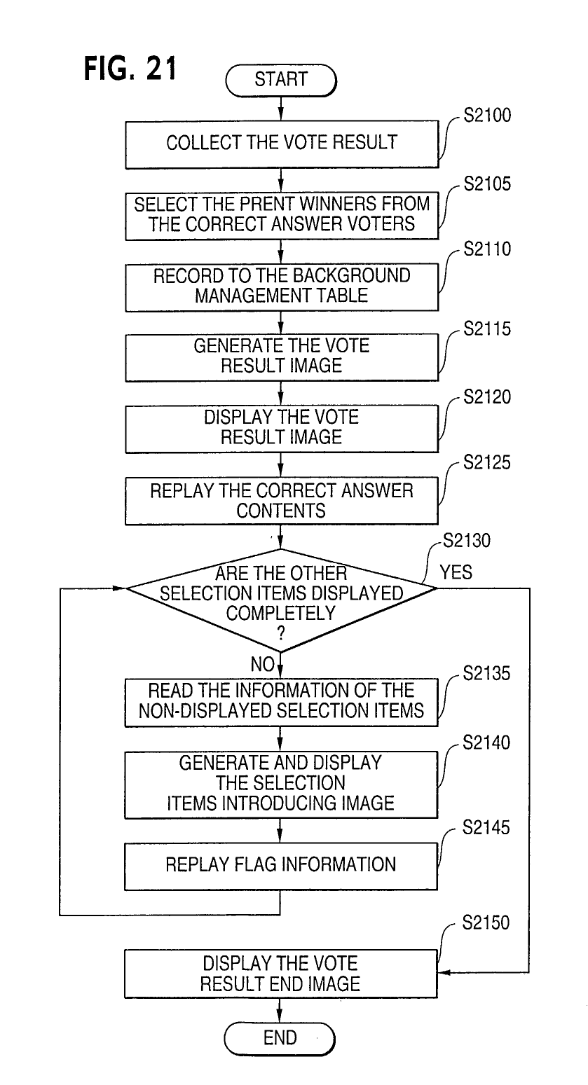

Thereafter, the contents that cannot obtain the maximum number of votes may be replayed sequentially. The practical method for such replay conforms to the processes at S2130 through S2145 of the contents display process flow shown in FIG. 21 in the second embodiment of the present invention.

When end of replay of contents is determined in S1550 as explained above, the request collecting unit 104 instructs the street video image editing/displaying unit 103 to close the contents display image 600 and display in turn the end image not shown. In combination, the request collecting unit 104 initializes (S1580) the attached video image files of viewers stored in the image identifier table 800, candidate selection table 900, viewer management table 10000 and voter DB 107 and thereby a series of process flow is completed.

Although not shown, the marketing information statistic unit 105 generates the marketing information for each contents provider based on the contents management table 700 and background management table 1100. As an example of the marketing information, popularity detected through comparison of various contents in regard to the particular ID 1130 is presented or it is advised to the contents provider that with which captured video image the contents of the particular ID 1130 can obtain the higher popularity. Or, it is also possible for a contents provider to use the displayed viewer addresses as the present sending information.

The marketing information statistic unit 105 may instructs, after having generated the marketing information, the web page editing/displaying unit 106 to generate the web page to reach it on the WWW. Thereby, a contents provider can read easily the marketing information using a contents provider terminal 113.

The second embodiment of the present invention is explained. In the second embodiment, one content captured video image is presented to the viewers to ask to select the correct answer from the selection items. This second embodiment is intended to store both contents of the correct answer and erroneous answer in the memory of viewers by replaying the advertisement content of correct answer and also replaying the other selection items as the erroneous answers.

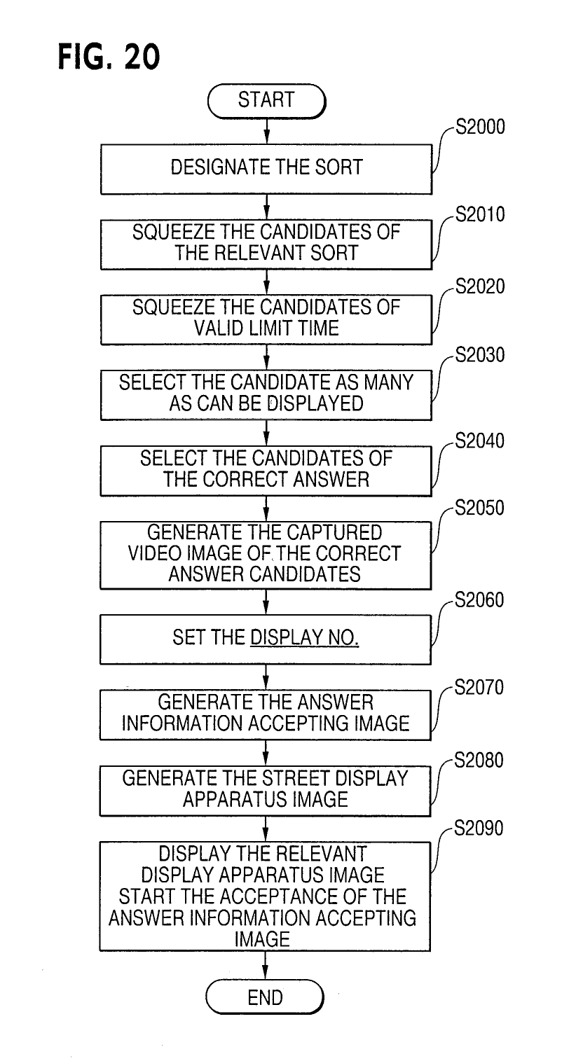

The process flow of the content selection display process S203 of the second embodiment is shown in FIG. 20. Because the process flow of FIG. 20 is basically identical to the content selection display process flow of FIG. 12 of the first embodiment of the present invention, only the differences will be explained.

In the second embodiment, when the candidates as many as can be displayed is selected in the S2030, the contents extracting unit 102 sets at random the content as the correct answer in S2040 and updates the replay flag 906 of the correct answer content to “01” from “00” in the selection candidate table 900. Next, the contents extracting unit 102 generates a captured video image only for the correct answer content (record in which the replay flag 906 is “01”) (S2050).

An answer information accepting web page 1700 generated at S2070 is shown in FIG. 17. The accepting page 1700 is formed of an display number 1710, selection items 1720 and 1730, a viewers nickname 1740, a message 1750, a part 1770 for inputting or selecting the attached image file directory, and a vote button 1760. Difference from the first embodiment is that selection of company names 1720 and 1730 and names of products 1740 and 1750 are displayed. This display may be realized by referring to the record corresponding to the ID 902 of the selection candidate table 900 from the contents management table 700.

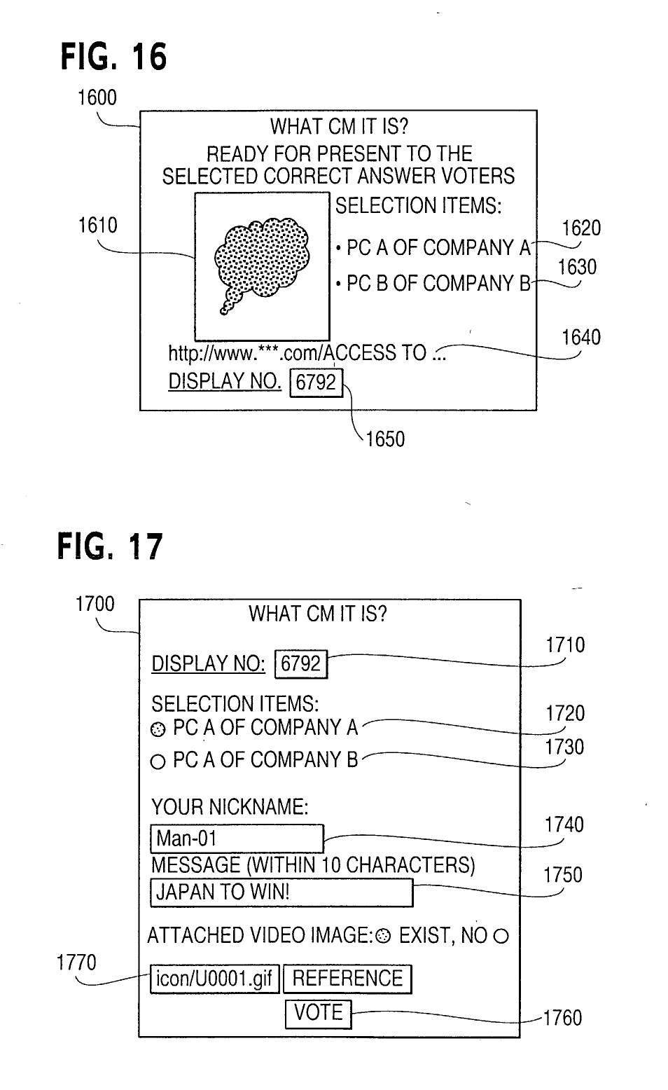

Moreover, a question display image 1600 generated in S2080 is shown in FIG. 16. The question display image 1600 is formed of a captured video image of correct answer content 1610, selection items 1620 and 1630, an answer information accepting web page URL 1640, and a display number 1650.

The selection information receiving process S208 of the second embodiment is identical to that of the first embodiment and is processed with the process flow of FIG. 14.

The process flow in regard to the collection process S208 and contents display process S210 of the second embodiment is shown in FIG. 21. Only the difference from the process flow of FIG. 15 in the first embodiment of the present invention will be explained. At S2100, the request collecting unit 104 calculates the total of the number of votes 905 in the selection candidate table 900, stores such numerical value into the job memory and refers to the number of votes 905 of the record in which the replay flag 906 is “01” to also store this value into the job memory.

Next, at S2105, the request collecting unit 104 selects at random a record from the group of records of viewers who have selected the selection numbers 901 of the correct answer content in the selection number 1010 of the viewer management table 1000 and changes the display flag 1060 of the selected record to “01” from “00”. The number of viewers extracted is previously set as desired depending on the instruction from the contents provider or intension of the street display administrator.

Thereafter, in S2110, the request collecting unit 104 writes the necessary data to the background management table 1100 based on the candidate selection table 900 and viewer management table 1000. Only difference from the first embodiment is, although not shown, that the ID column of the correct answer content is further added to the data items of the background management table 1100 and the request collecting unit 104 writes, to this ID column, the ID 902 of the record in which the replay flag 906 of the selection candidate table 900 is “01”. In the Cap-file 1150, only one captured video image file name of the correct answer is stored and moreover since the viewers are already extracted, the address 1030 of the record in which the display flag 1060 of the viewer management table 1000 is “01” is written into the address 1170.

The request collecting unit 104 then instructs the street video image editing/displaying unit 103 to generate a correct answer display image 1800 (S2115).

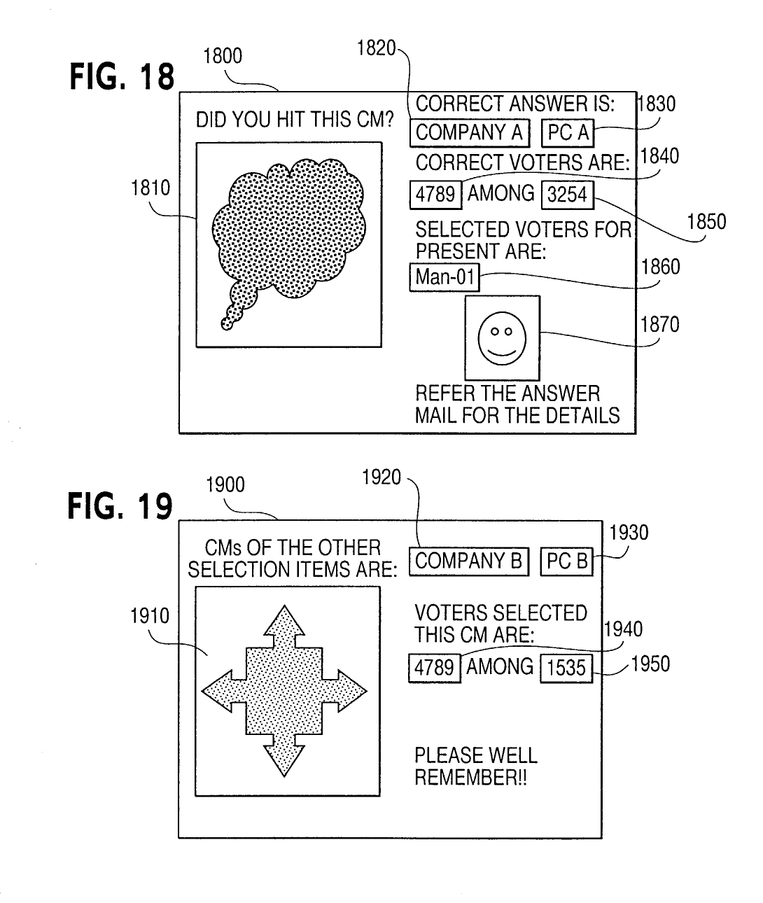

FIG. 18 shows the correct answer display image 1800. The correct answer display image 1800 is formed of a correct answer content 1810, a name of company 1820, a name of product 1830 of the correct answer content, the number of correct voters 1840, the number of total voters 1850, a nickname 1860 of the viewer extracted from the correct voters, and an attached image or a message 1870. The correct answer content 1810 is assigned by identifying, from the contents DB 108, the video data corresponding to the file 903 of the record in which the replay flag 906 of the selection candidate table 900. The user information 1860 and 1870 of the extracted viewers are assigned by referring to the record in which the display flag 1060 of the viewer management table 1000 is set to “01”. However, embodiments of the present invention are not so limited, as other numbers may be present in display flag logo that cause the record to be selected.

At S2120, the correct answer display image 1800 explained above is displayed and the correct answer content is then replayed at S2125.

When replay of the correct answer content is completed, contents of the other selection items are subsequently sequentially replayed.

The request collecting unit 104 determines whether contents of the other selections are all replayed at S2130. Specifically, it is determined at S2130 whether the replay flag 906 of the selection candidate table 900 is “01”. The request collecting unit 104 identifies, from the contents DB 108, the content data corresponding to the file 903 of the record in which the replay flag 906 is reads the name of company and the name of product from the contents management table 700 using the ID 902 as a key, and the total number of votes and the number of votes of the relevant content from the background management table 1100 (S2135), and instructs the street video image editing/displaying unit 103 to generate the other selection items display image 1910 and to display this image on the street display apparatus 110 (S2140).

FIG. 19 shows the other selection items display image 1900. The other selection items display image 1900 includes the other selection items contents 1910, a name of company 1920 of the relevant content and a name of product 1930, a total number of voters 1940, and a the number of votes of the relevant content 1950.

The request collecting unit 104 changes (S2145) the replay flag 906 of the record of the selection candidate table 900 corresponding to the replayed content to “01” from “00”. Here, the process returns again to S2130.

Thus, when the replay flag 906 of all records of the selection candidate table 900 becomes “01”, the request collecting unit 104 instructs the street video image editing/displaying unit 103 to end the display of the other selection items display image 1900, initialize the selection candidate table 900 and the viewer management table 1000, and delete the attached image file of the voter DB 107 to complete a series of the processes (S2150).

The statistic process S211 in the second embodiment of the present invention is similar to that in the first embodiment. Therefore, the same explanation is omitted here.

In the third embodiment, a question regarding the contents is displayed, on the web page to which the mobile terminal 112 makes access. Thereby, the street display apparatus 110 is capable of assigning longer time for the replay of contents. Moreover, a larger replay region can be acquired simultaneously.

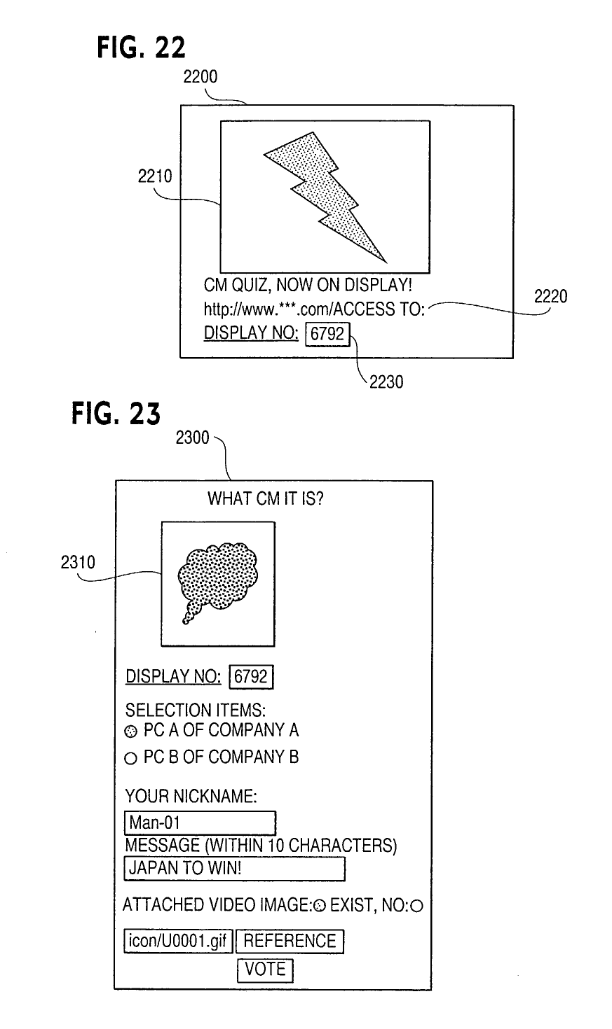

FIG. 22 shows a question display image 2200 displayed on the street display apparatus in the third embodiment. The question display image 2200 corresponds to the question display images 300 and 1600 but a large difference from such question display images is that the question display image 2200 only displays the display number 2230 and the URL 2220 of the web page presenting the question information and any practical question information is not displayed. However, the question display image 2200 displays the desired contents 2210 without relation to the question.

FIG. 23 shows a question web page 2300 on the WWW of the third embodiment. When a user accesses the URL 2200 of web page with a user terminal 112, this question page 2300 is displayed. The question page 2300 displays the captured image 2310 of the contents as the questions. The other display contents are identical to the answer information accepting pages 400 and 1700. Namely, the question web page 2300 has a format to issue the questions to users and also to receive the answers from the users. FIG. 23 shows an example of format of one web page but it is also possible to divide the same content for a plurality of pages.

The process flow of the content selection display process in the third embodiment is different only in the data element to generate the image explained above and image layout but is identical to the process flow of FIG. 12 in the question contents of the first embodiment and to the process flow of FIG. 20 in the question contents of the second embodiment. The same explanation is not repeated here. Moreover, the other process flows are also identical to that of the first or second embodiment. The same explanation is not repeated here.

Finally, the information editing apparatus 101 comprises a CPU, ROM, RAM, a hard disk drive (“HDD”), a hard disk (“HD”), a floppy disk drive (“FDD”), a floppy disk (“FD”) as an example of loadable/unloadable recording medium, a display, an interface (“I/F”), a keyboard, and a mouse. Moreover, such elements are coupled by a bus.

In an embodiment, the CPU controls the intermediate apparatuses as a whole. The ROM stores a program such as a boot program. The RAM is used as the work area of the CPU. The HDD controls the data read/write operation for the HD depending on the control of the CPU. The HD stores the written data under the control of the HDD.

The FDD controls the data read/write operations for the FD under the control of the CPU. The FD stores the written data under the control of the FDD and instructs the information processor to read the data recorded therein. As a loadable/unloadable recording medium, a CD-ROM(CD-R, CD-RW), an MO, a DVD (Digital Versatile Disc) and memory card may be used. A display displays a cursor, icons or tool box, and windows (browsers) in regard to the data such as documents, video images, and function information pieces. In an embodiment, a CRT, a TFT liquid crystal display, or a plasma display may be used as the display.

Functions of the contents registration process S202, content selection display process S203, selection information receiving process S208, collecting process S209, contents display process S210, and statistic process S211 of the information editing apparatus 101 can be realized when the CPU executes the programs stored in ROM, RAM, HD, and FD explained above.

The I/F is connected to the network such as a LAN and the Internet through the communication network and is also connected to the other information processor (e.g.: the server) via the network. Moreover, the I/F operates as the interface between the network and internal side and also controls the data input/output from the other servers or information terminals. In an embodiment, the I/F is a modem. Moreover, when the information providing apparatus makes communication by radio with a mobile telephone, the I/F is also provided with the function as a radio communication apparatus (radio transceiver).

Various types of data exchange of the information editing apparatus 101 with the mobile terminal 112, contents provider terminal 113 and outdoor display apparatus 110 can be realized with this I/F or the like. Moreover, the keyboard is provided with keys for inputting characters, numerals and various instructions to input various data. An input pad of the touch-panel type can also be used for such data input. A mouse is used to move the cursor, set the selection range, move the windows and change the size of windows. As a pointing device, a track-ball and a joy-stick may also be used while these are provided with the similar function.

### Effect of the Invention

As explained above, according to the information display method of the present invention, since the display identifier is updated whenever the question information displayed on the street display apparatus is changed, the collecting process can be executed based on only the answer information from viewers who are actually watching the videos displayed on the street display apparatus and thereby the practical marketing information can be served to the contents providers.

Moreover, according to the information display method of the present invention, the possibility of viewers who have originated the answer information pieces to have a certain interest in the displayed advertisement and remember it becomes higher by presenting a plurality of contents to the viewers to select the desired contents, regardless of the vote result. Moreover, it is also possible to give at a time to the viewers a deep impression not only of a mere advertisement but also of a plurality of contents in the same field.

Further, according to the information display method of the present invention, because the answer information pieces of viewers are collected by displaying a question to identify the content on the street display apparatus, and the correct answer and the erroneous answers are also displayed based on the collection result, it is possible to give, to viewers who have originated the answer information of the erroneous answers, a chance to newly memorize the content of their own answer and to give a chance, to the viewers who have originated the answer information correct answer, to newly recognize the contents resembling the correct answer.

Moreover, according to the information display method of the present invention, because only the video image as a part captured from the contents is displayed, an element of entertainment as a quiz can be enhanced, and collection of larger amount of answer information can be expected.

In the information display method of the present invention, because the collected user information of viewers is displayed together with the contents on the street display apparatus, the expectation that the information pieces, such as messages or images originated from viewers, may be displayed can be given to viewers. Thus, a greater number of answers may be collected.

Moreover, the present invention eliminates the difficulty of attracting the interest of viewers and impressing upon the viewers' memories an advertisement even if the advertisement is displayed on a street display apparatus.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An information display method for displaying desired content on an information display apparatus, comprising:
displaying a question regarding the desired content to a street display apparatus or a mobile terminal of a user;
collecting, via a network, a display identifier corresponding to the street display apparatus and an answer to the question; and
displaying the desired content on the street display apparatus based on the collected display identifier and the answer to the question.

2. The information display method of claim 1, wherein the question presents selection items for suggesting a plurality of contents, wherein the answer is a group of selection items that a user desires to watch, and wherein the desired content are displayed according to the most frequent answer chosen from among the collected answer.

3. The information display method of claim 2, wherein the selection items for suggesting a plurality of contents are contents in the same field.

4. The information display method of claim 1, wherein the question instructs the user to identify the desired content, wherein the desired content is displayed as the correct answer, and wherein content corresponding to erroneous answers collected is displayed.

5. The information display method of claim 1, wherein the question includes a video image captured from the desired content.

6. The information display method of claim 1, further comprising: collecting user information; and displaying the user information.

7. The information display method of claim 1, further comprising presenting marketing analysis information corresponding to the contents, on the network based on the answer.

8. An information display apparatus, comprising;
a question presenting unit displaying a question regarding desired contents of the information display apparatus to a street display apparatus or a mobile terminal of a user;
an answer information collecting unit collecting, via a network, a display identifier corresponding to the street display apparatus and an answer to the question; and
a content displaying unit displaying the desired contents on the street display apparatus based on the collected display identifier and the answer.

9. The information display apparatus of claim 8, wherein the question presents selection items suggesting a plurality of contents, wherein the answer is a group of selection items that a user desires to watch, and wherein the means for displaying the desired contents according to the most frequent answer chosen from the collected answers.

10. The information display apparatus of claim 9, wherein the selection items for suggesting a plurality of contents are contents in the same field.

11. The information display apparatus of claim 8, wherein the question instructs the user to identify the desired content, wherein the desired content is displayed as the correct answer, and wherein content corresponding to erroneous answers collected is displayed.

12. The information display apparatus of claim 8, wherein the question includes a video image captured from the desired content.

13. The information display apparatus of claim 8, wherein the collecting unit further collects user information, and wherein the desired content display unit further displays the user information.

14. The information display apparatus of claim 8, wherein marketing analysis information, corresponding to the contents, is presented on the network based on the answer.

15. A computer-readable storage medium including a program installed for functioning a computer and comprising:
a question presenting unit displaying the question regarding the desired contents on a street display apparatus or on a mobile terminal of user;
an answer information collecting collecting, via the network, a display identifier corresponding to said street display apparatus and an answer information to the question originated from the mobile terminal; and
a contents displaying unit displaying contents on the street display apparatus based on the collection result of the answer information.

16. The computer-readable storage medium of claim 15, wherein the question includes a video image captured from the contents.

17. The computer-readable storage medium of claim 15, wherein the answer information collecting unit further collects a user information and the contents display unit further displays the user information.

18. A program for functioning a computer and comprising:
a question presenting unit displaying the question regarding the desired contents on a street display apparatus or on a mobile terminal of user;
an answer information collecting unit collecting, via the network, a display identifier corresponding to the street display apparatus and an answer information to the question originated from the mobile terminal; and
a contents displaying unit displaying contents on the street display apparatus based on the collection result of the answer information.

19. A program according to claim 18, wherein the question includes a video image captured from the contents.

20. A program according to claim 18, wherein the answer information collecting unit further collects a user information and the contents display unit further displays the user information.

21. A computer-readable medium storing a program, said program when executed by a computer, causing the computer to execute the functions comprising:
displaying on an information display apparatus a question regarding desired contents;
collecting, via a network, a display identifier corresponding to the information display apparatus and an answer to the question originated from a mobile terminal; and
displaying the desired content on the information display apparatus based on the collected display identifier and the answer to the question.

22. The computer-readable medium according to claim 21, further comprising displaying an advertisement on the information display apparatus.

23. The computer-readable medium according to claim 21, wherein the question includes a video image captured from the contents.

24. The computer-readable medium according to claim 21, further comprising collecting and displaying user information.
